(19) United States
(12) Patent Application Publication
(10) Pub. No.: US 2005/0094192 A1
(43) Pub. Date: May 5, 2005

(54) Systems and methods for enabling electronic document ratification

(76) Inventors: Rodney Carl Harris, Ft. Collins, CO (US); Michael David Erickson, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/700,287

(22) Filed: Nov. 3, 2003

(51) Int. Cl. G06F 15/00

(52) U.S. Cl. 358/1.15

(57) ABSTRACT

Disclosed are systems and methods for enabling electronic document ratification. In one embodiment, a system and a method pertain to receiving an unmodifiable document with a document receiving device, collecting handwritten content from a recipient of the document, and adding data reflective of the handwritten content to the document without scanning original content of the document.

### BACKGROUND

Documents are often ratified by a signature or other mark. For instance, legal contracts typically require the contracting parties to sign and date the contract to render it enforceable. When a person's ratification is required for a document and that person is geographically remote from the person who created the document, the traditional solution is to mail or hand deliver the document to the ratifying person, and have that person ratify the document and mail it back. This process is inefficient, however, and may require several days before the ratified document is returned to the person who created it.

In recent years, facsimile technology has come into common use for obtaining document ratification. In such a case, a first person may fax a document to a second person (i.e. the recipient) who is to ratify the document. Upon receiving the document, the recipient can ratify the document (e.g., initial and/or sign the document) and fax the document back to the first person. Although more efficient than the above-described process, this procedure can result in a relatively poor-quality end product in that the document is scanned multiple times. Especially poor results may occur in cases in which the document comprises small print and/or is faxed several times (e.g., to multiple parties each of whom ratify the document).

Other electronic solutions are now available for document ratification. For instance, a document may be digitally transmitted using what is commonly referred to as a “digital sender.” In such a case, a hard copy document is scanned by the digital sender, which attaches the document to an email message (e.g., as a PDF file) that is sent to the recipient. The recipient can receive the document using a computer, print the document, sign it, and then transmit it back to the person who sent it to the recipient. Such return transmission may comprise a facsimile transmission or a further digital sending transmission. In either case, however, the document content is scanned multiple times, thereby also creating potential document quality problems.

Another electronic method can be used to achieve document ratification. In particular, a first person can create a document in a given program (e.g., a word processing program) and email the document (e.g., as a word processing file attachment) to a recipient with the expectation that the recipient will simply print it out, sign it, and transmit it back to the first person by faxing or digitally sending. Such a process results in the document content only being scanned once, and therefore may yield a higher quality result. Unfortunately, however, such a process provides the recipient with a means for easily altering the terms of the document prior to printing and ratifying (e.g., altering the document using the same word processing program in which the document was created). Although this may not be a concern in some cases, it may be a serious problem in others, for instance if the document is a legally-binding contract. Moreover, quality issues can still arise if the printed document is thereafter transmitted multiple times, for instance to obtain ratification of other, geographically-separated persons.

### SUMMARY OF THE DISCLOSURE

Disclosed are systems and methods for enabling electronic document ratification. In one embodiment, a system and a method pertain to receiving an unmodifiable document with a document receiving device, collecting handwritten content from a recipient of the document, and adding data reflective of the handwritten content to the document without replacing original content of the document.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system for enabling electronic document ratification.

FIG. 2 is a block diagram of an embodiment of a document sending device shown in FIG. 1.

FIG. 3 is a block diagram of an embodiment of a document receiving device shown in FIG. 1.

FIG. 4 is a flow diagram that illustrates an embodiment of a method for enabling electronic document ratification.

FIG. 5 is a flow diagram that illustrates an embodiment of operation of a sender-end document ratification manager of the document sending device of FIG. 2.

FIGS. 6A-6B provide a flow diagram that illustrates an embodiment of operation of a recipient-end document ratification manager of the document receiving device of FIG. 3.

FIG. 7 is a schematic view of an example document and identifies an input block of the document.

FIG. 8 is a flow diagram that illustrates another embodiment of operation of a recipient-end document ratification manager of the document receiving device of FIG. 3.

### DETAILED DESCRIPTION

Disclosed herein are systems and methods with which a document can be electronically transmitted to a recipient and ratification content (e.g., initials and/or a signature) of the recipient can be added to the document such that no document content is re-scanned and reused to generate a document. Although particular embodiments are disclosed, these embodiments are provided for purposes of example only to facilitate description of the disclosed systems and methods.

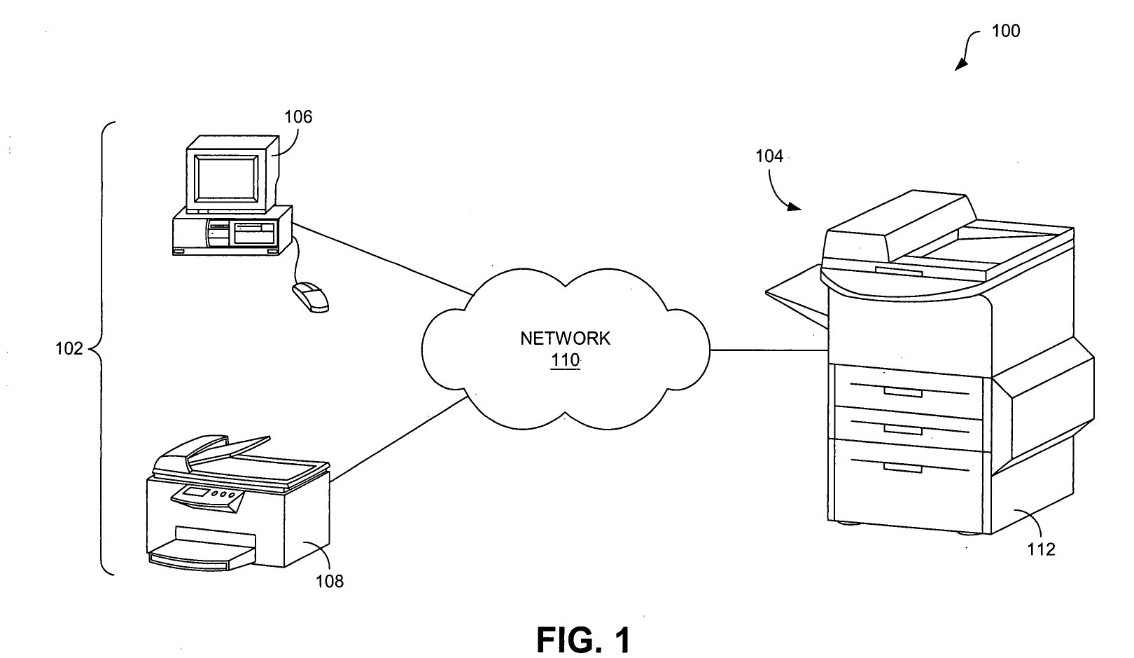

Referring now in more detail to the drawings, in which like numerals indicate corresponding parts throughout the several views, FIG. 1 illustrates an example system 100. As indicated in that figure, the system 100 generally comprises one or more document sending devices 102 and a document receiving device 104. Although the terms “document sending device” and “document receiving device” are used, it will be appreciated from the following discussion that the document sending devices may further be capable of receiving documents and the document receiving device may further be capable of sending documents. Therefore, those terms are selected not to limit the disclosure but to facilitate discussion of system operation.

In the embodiment of FIG. 1, two document sending devices 102 are shown including a user computer 106 that is configured to transmit stored documents over a network, and a digital sender 108 that is configured to scan hard copy documents and transmit them over a network in digital form. Although those particular document sending devices 102 are shown and have been explicitly identified herein, other sending devices may be implemented in the system 100. For instance, the sending devices 102 may comprise a multi-function peripheral (MFP) device that is configured to perform multiple functions such as printing, copying, scanning, and transmitting. Indeed, an appropriate document sending device can comprise any device that is configured to digitally transmit documents to a document receiving device.

In the embodiment of FIG. 1, the document receiving device 104 comprises an MFP device that is at least configured to receive documents. More generally, however, the document receiving device 104 comprises a device that can receive documents in a digital form and obtain ratification content to add to such documents. As is described in greater detail below, the document receiving device 104 may further be configured to print, scan, and/or transmit documents.

The document sending devices 102 and the document receiving device 104 are linked by a network 110. The network 110 normally comprises multiple sub-networks that are communicatively coupled to each other. By way of example, the network 110 comprises one or more local area networks (LANs) and one or more wide area networks (WANs) that comprise part of the Internet. In some embodiments, the document sending devices 102 and the document receiving device 104 may be connected to separate LANs (e.g., a first LAN in a first office or home, and a second LAN in a second office or home).

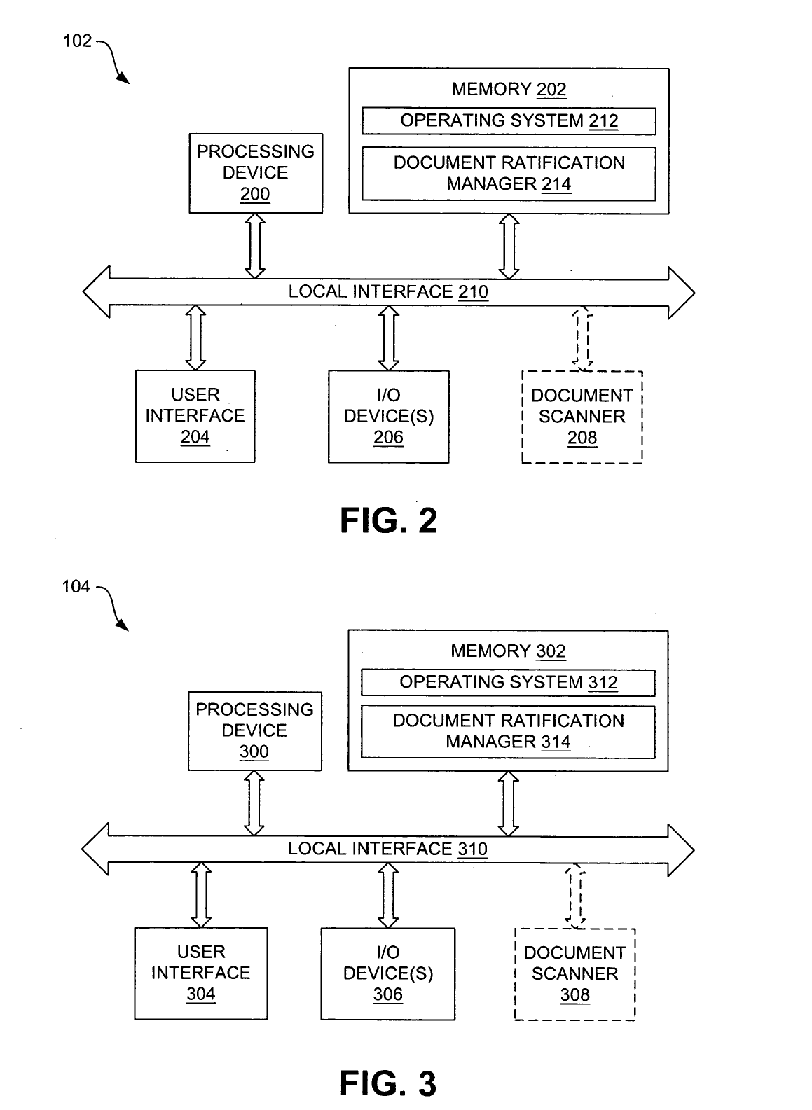

FIG. 2 is a block diagram illustrating an example architecture for a document sending device 102 shown in FIG. 1. As indicated in FIG. 2, the document sending device 102 comprises a processing device 200, memory 202, a user interface 204, at least one input/output (I/O) device 206, and, optionally, a document scanner 208. Each of those components is connected to a local interface 210 that, by way of example, comprises one or more internal buses.

The processing device 200 is adapted to execute commands stored in memory 202 and can comprise a general-purpose processor, a microprocessor, one or more application-specific integrated circuits (ASICs), a plurality of suitably, configured digital logic gates, and other electrical configurations that coordinate the overall operation of the document sending device 102. The memory 202 comprises any one or a combination of volatile memory elements (e.g., random access memory (RAM)) and nonvolatile memory elements (e.g., read-only memory (ROM), Flash memory, hard disk, etc.).

The user interface 204 comprises the components with which a user interacts with the document sending device 102. In cases in which the document sending device 102 comprises a computer (e.g., user computer 106, FIG. 1), the user interface 204 may comprise a keyboard, mouse, and a display such as a cathode ray tube (CRT) or liquid crystal display (LCD) monitor. In cases in which the document sending device 104 comprises a digital sender (e.g., digital sender 108, FIG. 1) or a similar peripheral and/or walk-up device, the user interface 204 may comprise a control panel that includes one or more function keys. Such a control panel may further include a display, such as liquid crystal display (LCD) or light emitting diode (LED) display.

The one or more I/O devices 206 facilitate communications with other devices over the network 110, such as the document receiving device 104, and therefore may include a modulator/demodulator (e.g., modem), network card, wireless (e.g., radio frequency (RF)) transceiver, or other communication component.

In cases in which the document sending device 102 includes the document scanner 208, for instance in cases in which the device is a digital sender or a similar device, the scanner is configured to scan hard copy documents to generate data that can be transmitted to a desired recipient. By way of example, the scanner 208 comprises a flatbed scanner that includes a glass platen, various optics (lenses, mirrors, etc.), one or more drive motors, and one or more image sensors (e.g., charge-coupled devices (CCD)). In cases in which the document sending device 102 does not comprise a scanner (e.g., if the device is a computer such as user computer 106, FIG. 1), the data to be transmitted may originate from device memory 202.

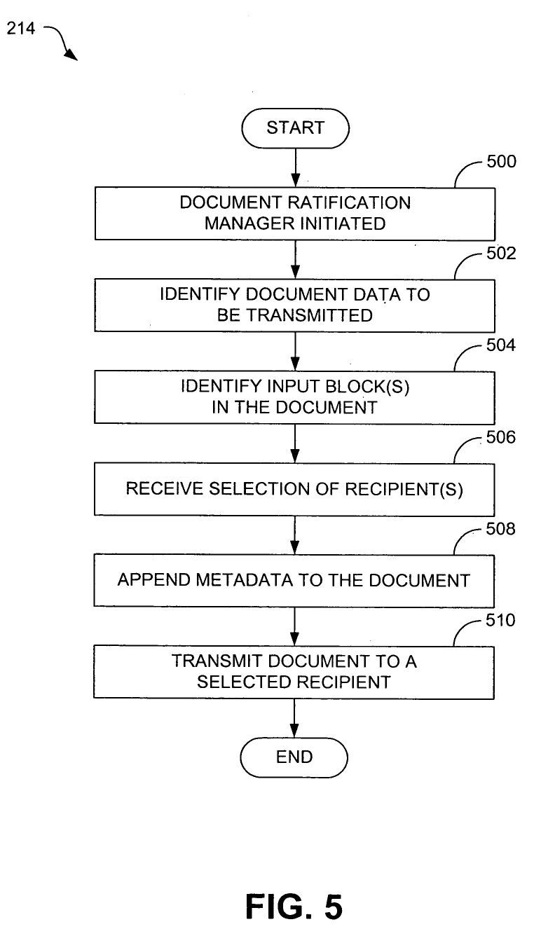

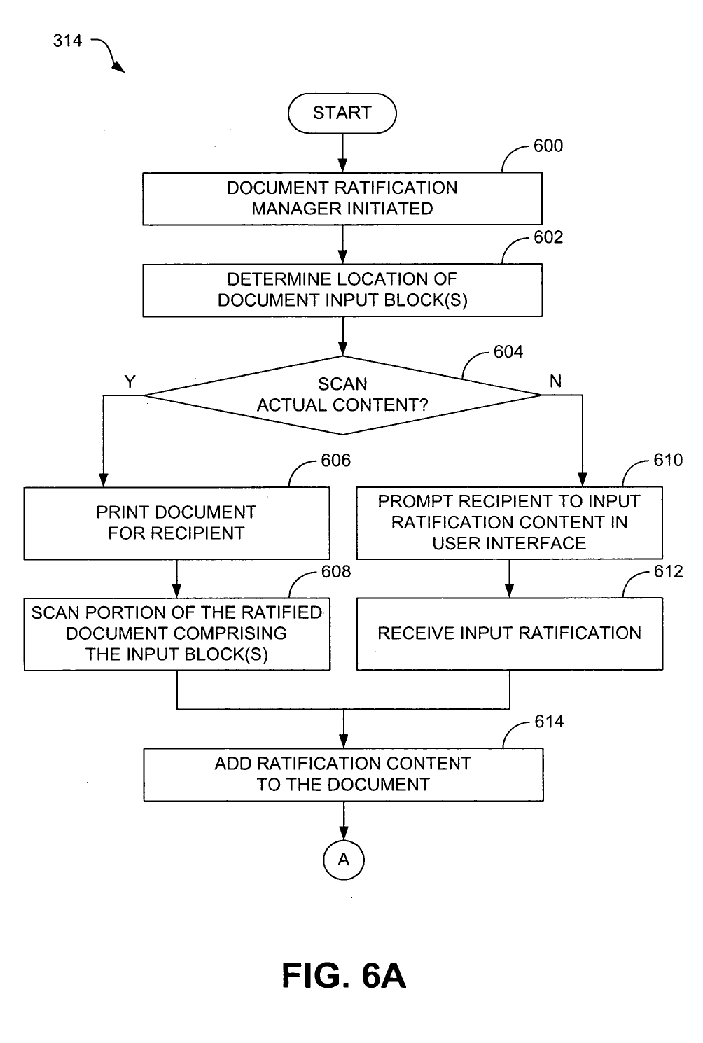

The memory 202 includes various programs including an operating system (O/S) 212 and a sender-end document ratification manager 214. The O/S 212 controls the execution of other programs and provides scheduling, input-output control, file and data management, memory management, and communication control and related services. In some embodiments, the document ratification manager 214 comprises logic that is configured to identify portions of a document to which ratification content is to be added. Operation of the document ratification manager 214 is discussed in greater detail in relation to FIGS. 4 and 5 below.

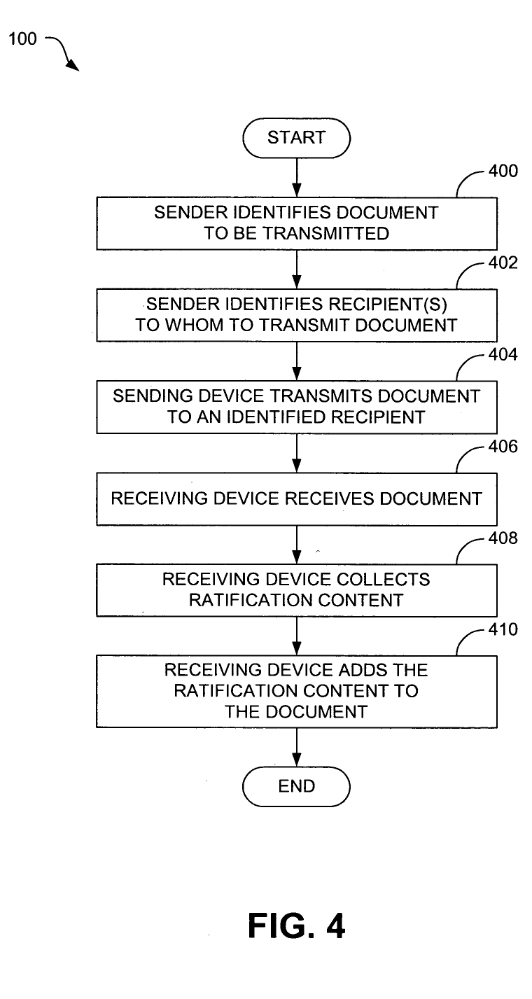

FIG. 3 is a block diagram illustrating an example architecture for the document receiving device 104 shown in FIG. 1. As indicated in FIG. 3, the document receiving device 104 comprises a processing device 300, memory 302, a user interface 304, at least one I/O device 306, and, optionally, a document scanner 308, each of which is connected to a local interface 310.

The processing device 300 can include a general-purpose processor, a microprocessor, one or more application-specific integrated circuits (ASICs), a plurality of suitably configured digital logic gates, and other electrical configurations that coordinate the overall operation of the document receiving device 104. The memory 302, like memory 202 of the document sending device 102, includes any one of or a combination of volatile memory elements (e.g., RAM) and nonvolatile memory elements (e.g., hard disk, read only memory (ROM), etc.).

The user interface 304 comprises the tools with which the device settings can be changed and through which the user can communicate commands to the document receiving device 104. By way of example, the user interface 304 comprises one or more function keys contained within a device control panel. Such a control panel may further include a display, such as an LCD or LED display. In some embodiments, the user interface 304 further includes a handwriting input device, such as a touch-sensitive screen, in which the user can manually input ratification content using an appropriate writing implement such as a stylus.

With further reference to FIG. 3, the one or more I/O devices 306 are adapted to facilitate network-based communications and therefore include one or more communication components such as a modulator/demodulator (e.g., modem), network card, wireless (e.g., (RF)) transceiver, etc.

In cases in which the document receiving device 104 includes the document scanner 308, the scanner may, for instance, comprise a flatbed scanner that includes a glass platen, various optics (lenses, mirrors, etc.), one or more drive motors, and one or more image sensors (e.g., charge-coupled (CCD) devices, complementary metal oxide semiconductor (CMOS) devices, etc.).

The memory 302 comprises various programs including an O/S 312 and a recipient-end document ratification manager 314. The O/S 312 controls the execution of other programs and provides scheduling, input-output control, file and data management, memory management, and communication control and related services. The recipient-end document ratification manager 314 comprises logic that is configured to receive a document transmitted by a document sending device, collect ratification content provided by the recipient, and add the ratification content to the document (i.e., to the digital document data). In some embodiments, the document ratification manager 314 is further configured to scan ratification content (to the exclusion of other document content) and/or transmit the ratified document (e.g., back to the original sender or to a new recipient). Operation of the document ratification manager 314 is described in relation to FIGS. 4, 6, and 8 below. Although the recipient-end document ratification manager 314 is shown and described as residing on a document receiving device that may include printing capabilities (e.g., MFP 112, FIG. 1), it is to be appreciated that the manager, or a portion thereof, could reside on a user computer (e.g., PC) that acts alone or in concert with such a printing device, depending upon the implementation.

Various programs (i.e. logic) have been described herein. These programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Example systems having been described above, operation of the systems will now be discussed. In the discussions that follow, flow diagrams are provided. Process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

FIG. 4 provides an overview of an example method for enabling electronic document ratification. Beginning with block 400 of FIG. 4, a sender identifies a document that is to be transmitted. The nature of such identification may depend upon the configuration of the document sending device. For example, if the document sending device comprises a computer (e.g., user computer 106, FIG. 1), document identification may comprise selecting the document file from a directory of a program that executes on the computer. If the document sending device comprises a peripheral and/or walk-up device, document identification may comprise inserting a hard copy document into an automatic document feeder (ADF) of the device for purposes of scanning the document into device memory. In either case, the document comprises a document that is to be ratified in some manner. Such ratification may, for instance, require the addition of initials, one or more signatures, an authorization stamp, or the like.

Once the document has been identified, the sender identifies one or more recipients that are to receive the document, as indicated in block 402. If multiple recipients are identified, the sender may specify sequential distribution (and thereafter transmission) of the document to facilitate ratification by multiple, geographically-separated people. For instance, if the document comprises a loan that requires the signatures of an obligee and a co-signer that are located at different geographical locations, the sender may specify that the document is to first be sent to the obligee for signature, and then to the co-signer for signature. In addition to identifying multiple recipients, the sender can also specify that the document is to be sent back to the sender once it has been ratified by all recipients.

Next, the document sending device transmits the document to an identified recipient, as indicated in block 404. As described above, this transmission comprises a transmission over an appropriate network (e.g., network 110, FIG. 1). Once the document has been transmitted, the recipient's document receiving device receives the transmitted document, as indicated in block 406. At this point, the document receiving device collects user-provided ratification content that is to be added to the document, as indicated in block 408. Again, such ratification content may comprise one or more of initials, one or more signatures, an authorization stamp, or the like.

The manner in which the ratification content is collected by the document receiving device may depend upon the capabilities of the device and/or the current settings activated for the device (either default settings or user-selected settings). For example, if the document receiving device comprises a printer and a scanner, collection of the ratification content may comprise scanning the ratification content from a print-out of the document to which the recipient has added content (e.g., by signing the document). If the document receiving device comprises a handwriting input device, collection of the ratification content may comprise collecting handwritten marks input by the user into the input device.

Irrespective of the manner in which the ratification content is collected, the collected content is then added by the receiving device to the document, as indicated in block 410. In cases in which the ratification content is collected using a handwriting input device, the placement of the content within the document may be determined from information provided by the document sending device. For instance, the document sending device can have included metadata along with the document that identifies the location of an input block in which such content is to be placed. As is described in greater detail below, such metadata can further be used to indicate what portions of a print-out of the document to scan in cases in which the ratification content is scanned by the document receiving device.

At this point, a ratified document, i.e. a document that contains the ratification content provided by the recipient, is contained in memory on the document receiving device. Various further manipulation of the document data can then be performed, if desired. For example, as is described in greater detail below, the ratified document can be printed for the recipient by the document receiving device (assuming that device has printing capabilities), stored to a desired memory location (e.g., device hard disk or a hard disk of a separate computer), or transmitted to another person. As for further transmission, the ratified document can be, for instance, transmitted back to the original sender for his or her records, or transmitted to a next recipient who is also expected to ratify the document.

FIG. 5 provides an example of operation of the sender-end document ratification manager 214 that executes on a document sending device 102. Beginning with block 500 of FIG. 5, the document ratification manager 214 is initiated. That initiation can occur, for example, when the sender (i.e., user) indicates a desire to transmit a document that is to be ratified by at least one recipient. Such a desire can be communicated by selecting an appropriate option presented in a graphical user interface (GUI) associated with a computer program (e.g., a word processing program executing on a computer), or presented in a device control panel.

Once the document ratification manager 214 is initiated, the manager identifies a document that is to be transmitted, as indicated in block 502. Such identification may, for instance, occur after the sender selects a document file that is stored in device memory 202 or after the sender scans a hard copy document with the document sending device 102. Regardless, the document comprises an unmodifiable document, such as a PDF file, that is in a format in which the original content of the document cannot be changed, for instance using a user application such as a word processing program. In cases in which a stored document file is identified in block 502, the document may have been created by scanning a hard copy document at an earlier time. The document ratification manager 214 next identifies at least one input block in the document to which ratification content of a recipient is to be added, as indicated in block 504.

The document ratification manager 214 can identify the block(s) in various ways. In one method, identification may merely comprise receiving a user input that describes the physical location of the input blocks in relation to the layout of the document as a printed document. For example, the user can input coordinates that describe two or more corners of a rectangular area of the document that defines its borders. Alternatively, the user can select one or more of several standardized input blocks with the user interface whose locations are known to the document sending device. In another method, the document ratification manager 214 can automatically detect the location of the block(s). In such a case, the input block(s) may be defined by distinguishing marks in the document that identify the input block boundaries that the document ratification manager 214 can readily identify.

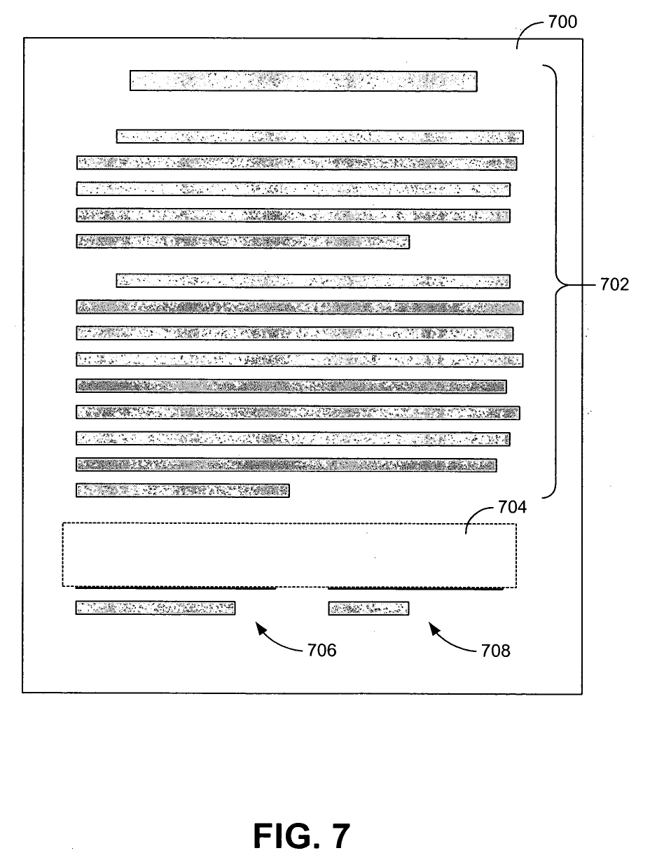

FIG. 7 illustrates an example document 700 that comprises an input block. As shown in FIG. 7, the document 700 comprises various original content 702, such as text, that the document comprises. At the end of the document 700 is provided an input block 704 that is associated with a signature block 706 in which a signature is to be written, and a date block 708 at which the date the signature was written is to be written. Although the input block 704 can be explicitly identified on the document (e.g., when it is printed out by the recipient for purposes of actually signing the hard copy document), the borders of the block need not be identified, particularly in cases in which it is large enough to encompass the likely portion of the document in which the recipient will add ratification content.

Returning to FIG. 5, the document ratification manager 214 next receives selection of the recipient or recipients who are to receive the document, as indicated in block 506. The recipients can be identified by the user by, for example, by selecting recipient names from an address book stored in device memory 202 and/or by manually entering recipient addresses. Through the user selections, the document ratification manager 214 can identify addresses of the recipients' document receiving devices to which the document is to be sent.

If the document is to be sent to multiple recipients, the received selections may further comprise selection of a sequential distribution order that is to be implemented. For example, if the document is to be ratified by multiple persons in different geographical locations, each of whom has a document receiving device, the sender can specify that the document is to be transmitted to the first person, ratified by that person, transmitted to the second person, ratified by that person, and so forth. Moreover, the sender can also specify that the document is to be returned after having been ratified by each recipient.

At this point, the document ratification manager 214 appends metadata to the document (i.e. the digital document data). The metadata at least identifies that the document is to be ratified, and may further describe the location of the input block(s). By way of example, the metadata may comprise x and y coordinates on a document page that define the boundaries of the input block(s). In addition, the metadata may describe transmission instructions that are to be implemented after the first recipient ratifies the document. For instance, such metadata may indicate that, after the document is ratified by the first recipient, the document is to be transmitted to the second recipient for ratification and, after ratified by the second recipient, the document is to be transmitted back to the sender. In cases in which there are multiple ratifying recipients, the metadata may further identify the location of the input blocks relative to the particular recipients. For instance, if the document contains three signature blocks specifically intended for three different ratifiers, the metadata can associate the recipient address with the particular input block in which that recipient's signature is to be added.

With reference next to block 510, the document ratification system 214 transmits the document to a selected recipient, whether the recipient is the sole recipient or the first of a group of recipients. At this point, flow for the document transmission session is terminated.

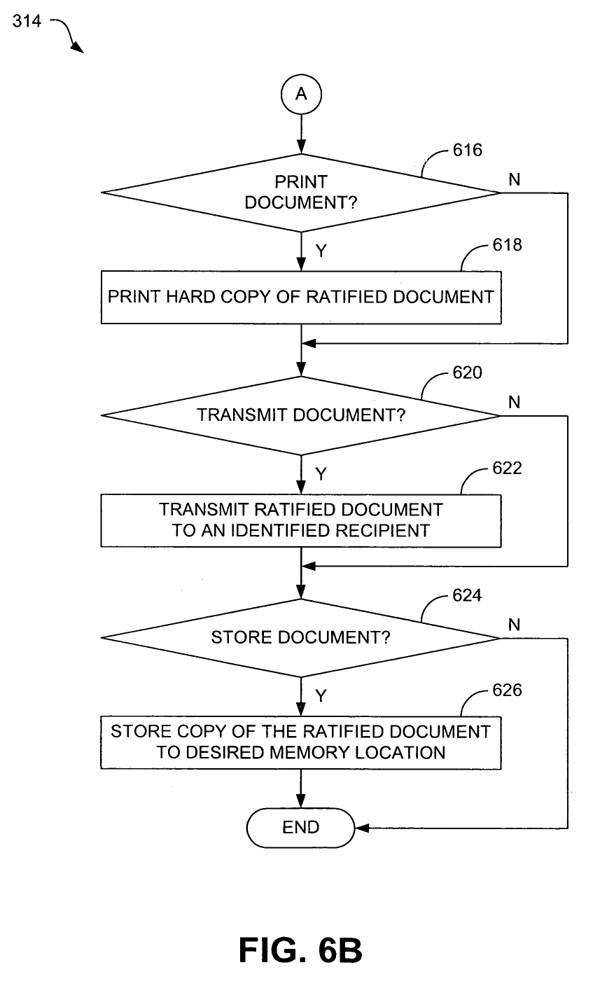

FIGS. 6A and 6B provide an example of operation of the recipient-end document ratification manager 314 that executes on the document receiving device 104. Beginning with block 600 of FIG. 6A, the document ratification manager 314 is initiated. Such initiation may occur when an unmodifiable document (e.g., PDF file) is received that includes metadata indicating that the document is to be ratified by the recipient user. Next, with reference to block 602, the document ratification manager 314 determines the location of the one or more input blocks of the document. The nature of this determination depends upon the data that the document sending device transmitted to the document receiving device 104. For example, if the document sending device transmitted metadata that explicitly describes the location of the input block(s), determination of the location of the input block(s) simply comprises reading the metadata for this information. Alternatively, if no such information was provided by the document sending device, determination of the input block location(s) may comprise detecting the location of the block(s) by distinguishing marks that identify block boundaries.

Flow from this point depends upon the manner in which the ratification content is to be collected. In particular, flow depends upon whether the ratification content is to be scanned from a hard copy document, or collected using a touch-sensitive screen of the document receiving device 104. In any case, the content comprises handwritten content. Accordingly, with reference to decision block 604, if actual content is to be scanned, flow continues to block 606 at which the document received from the document sending device is printed to enable the recipient (i.e., user) to add ratification content (e.g., a signature). Assuming the user adds such content where indicated (e.g., by an explicitly-shown input block or by an appropriate signature block), the content will be provided in a location in the document at which it can be scanned by the document receiving device 104.

Once the recipient adds content to the document (e.g., executes the document) to ratify it, the recipient can provide the ratified document to the document receiving device 104 for scanning. For example, the recipient can insert the document into an ADF of the document receiving device 104. At this point, the document receiving device 104, under the control of the document ratification manager 314, scans the input block(s), as indicated in block 608. More particularly, the document ratification manager 314 controls the document receiving device 104 so that only the portion of the document comprising the input block(s) is scanned. With this manner of operation, only the ratification information is scanned and captured.

With reference back to decision block 604, if actual content is not to be captured, i.e. digital ratification content is to be collected using a handwriting input device of the document receiving device 104, flow continues to block 610 at which the document ratification manager 314 prompts the user to input the ratification content in the input device. The manager 314 can then receive the input ratification (e.g., a signature signed within a stylus) as indicated in block 612.

After the ratification content has been received either through scanning (block 608) or through a user interface (block 612), the ratification content is in digital form. Therefore, the document ratification manager 314 can add the ratification content to the document, as indicated in block 614, so as to form a ratified document in digital form. The ratification content is added to the input block to which it relates. For instance, if the recipient is the second recipient to ratify the document, the ratification content provided by that recipient is matched with the particular input block at which that content is to be provided (e.g., a signature is placed above or next to the user's typewritten name). As described above in relation to FIG. 5, the correlation between the ratification content and its correct placement in the document can be conveyed to the document receiving device in metadata that accompanied the document.

At this point, a ratified document is resident in device memory 202. Various further steps may then be performed in accordance with the recipient's wishes and/or in accordance with the wishes of the original sender. As noted above in relation to FIG. 4, options include printing the ratified document, storing the ratified document, and transmitting the ratified document. Therefore, with reference to decision block 616 of FIG. 6B, the document ratification manager 314 determines whether the document is to be printed using the recipient's document receiving device 104. This determination may simply reflect the recipient's wishes (e.g., communicated by receipt, or no receipt, of a “print” command). If no hard copy is to be printed, flow continues to decision block 620 described below. If, on the other hand, a hard copy is to be generated, flow continues to block 618 at which the hard copy is printed.

With reference to decision block 620, the document ratification manager 314 also determines whether to transmit the ratified document to a given destination. By way of example, the destination could be the document receiving device of another person who is to ratify the document or the sender who originally transmitted the document to the first recipient. A determination to transmit the ratified document may be made upon receiving a command from the recipient to transmit the document to a given new recipient. Alternatively, that determination may be made in view of distribution instructions contained in the metadata provided by the document sending device. For instance, those instructions could request the document receiving device 104 to transmit the ratified document to the next ratifier in a distribution list. Such instructions may instead request the document receiving device to transmit the document back to the sender.

If it is determined not to transmit the ratified document, flow continues to decision block 624 described below. If the document is to be transmitted, however, flow continues to block 622 at which the ratified document is transmitted to an identified recipient.

With reference next to decision block 624, the document ratification manager 314 determines whether to store the document to a desired memory location beyond the volatile memory of the document receiving device 104. If the recipient does not desire to store such a copy (e.g., a printed hard copy is believed to be adequate), flow for the ratification session is terminated. However, if such storage is desired, flow continues to block 626 at which a copy of the ratified document is stored. By way of example, the document can be stored on the document receiving device 104 (e.g., in a device hard disk). Alternatively, the document can be stored on a separate computer (e.g., a separate personal computer (PC)) by delivering the document to that computer.

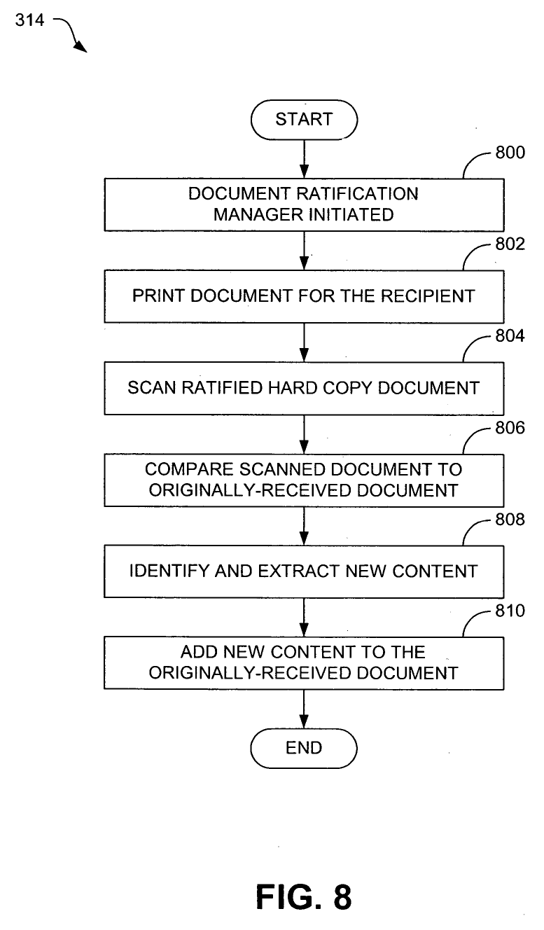

FIG. 8 provides a further example of operation of the recipient-end document ratification manager 314. In this example, the manager 314 does not identify input blocks of the received document to identifying, and/or determine where to place, ratification content. Instead, the ratification content provided by the recipient is detected through document comparison. Beginning with block 800 of FIG. 8, the document ratification manager 314 is initiated. Again, such initiation may occur when an unmodifiable document (e.g., PDF file) is received that includes metadata indicating that the document is to be ratified by the recipient user. Next, with reference to block 802, the document ratification manager 314 controls the document receiving device 104 to print the received document to enable the recipient to add ratification content to the document.

Once the document is printed, the recipient adds content to the document to ratify it, for instance by adding initials, a signature, and/or other marks. At this point, the recipient provides the ratified hard copy document to the document receiving device 104 for scanning and the document receiving device, under the control of the document ratification manager 314, scans the entire document, as indicated in block 804.

Next, the document ratification manager 314 compares the scanned document to the originally-received document, as indicated in block 806, for the purpose of determining what content the recipient added to the document. Accordingly, at block 808, the document ratification manager 314 identifies and extracts the new content. Such identification can be accomplished by simply comparing the digital data comprising the two documents and simply identifying any differences in the data.

Once such extraction has been performed, the new content, including the recipient's ratification content, is in digital form. Therefore, the document ratification manager 314 can add the new content, and only that content, to the originally-received document, as indicated in block 810, so as to form a ratified document in digital form. Notably, any additions and/or changes made to the original document by the recipient are added to the original document. Therefore, the embodiment of operation described in relation to FIG. 8 enables the recipient to modify the document in addition to, or in exception to, merely ratifying it, and such modifications will be clearly visible to others (including the sender who created the document). At this point, the ratified document is resident in device memory 202 and the various further steps described above in relation to FIG. 6B may then be performed, if desired, including one or more of printing, transmitting, and storing the ratified document.

As can be appreciated from the foregoing, irrespective of the manner in which the ratification content is collected, no content of the ratified document is replaced (i.e. re-scanned and used to form a new document). Specifically, the original document content may have been scanned once, but is not reused even though the ratification content of one or more recipients may be scanned. Therefore, the quality of the document can remain relatively high, irrespective of the number of times it is transmitted for purposes of ratification.

1. A method for enabling electronic document ratification, the method comprising:
receiving an unmodifiable document with a document receiving device;
collecting handwritten content from a recipient of the document; and
adding data reflective of the handwritten content to the document without replacing original content of the document.

2. The method of claim 1, wherein receiving an unmodifiable document comprises receiving an unmodifiable document with a multi-function peripheral (MFP) device.

3. The method of claim 1, wherein receiving an unmodifiable document comprises receiving a PDF file.

4. The method of claim 1, wherein receiving an unmodifiable document comprises receiving a file containing scanned data.

5. The method of claim 1, wherein collecting handwritten content comprises collecting handwritten content from a recipient of the device using the document receiving device.

6. The method of claim 1, wherein collecting handwritten content comprises scanning handwritten content using the document receiving device.

7. The method of claim 6, wherein scanning handwritten content comprises only scanning handwritten content that was manually added to a printout of the document.

8. The method of claim 7, wherein only scanning handwritten content that was manually added comprises only scanning handwritten content contained within an input block of the document.

9. The method of claim 6, wherein scanning handwritten content comprises scanning an entire printout of the document and comparing data obtained through the scanning with data of the received unmodifiable document.

10. The method of claim 1, wherein collecting handwritten content comprises collecting handwritten marks entered by the recipient in a handwriting input device of the document receiving device.

11. The method of claim 1, wherein adding data comprises adding data within an input block of the unmodifiable document.

12. The method of claim 1, further comprising at least one of printing the document after the data has been added, transmitting the document after the data has been added, and storing the document after the data has been added.

13. The method of claim 1, further comprising sending an unmodifiable document to the document receiving device.

14. The method of claim 13, further comprising identifying an input block of the unmodifiable document prior to sending the unmodifiable document.

15. The method of claim 13, further comprising adding metadata to the unmodifiable document that identifies that the document is to be ratified.

16. The method of claim 13, further comprising adding metadata to the unmodifiable document that identifies a location of an input block of the document.

17. A system for enabling electronic document ratification, the system comprising:
means for transmitting an unmodifiable document;
means for receiving the transmitted document;
means for collecting handwritten content from a recipient of the document; and
means for adding data reflective of the handwritten content to the document without replacing original content of the document.

18. The system of claim 17, wherein the means for transmitting comprise at least one of a digital sender and a multi-function peripheral (MFP) device.

19. The system of claim 17, wherein the means for receiving comprise a multi-function peripheral (MFP) device.

20. The system of claim 17, wherein the means for collecting handwritten content comprise a document scanner.

21. The system of claim 20, further comprising means for controlling the document scanner to only scan the handwritten content.

22. The system of claim 20, further comprising means for comparing scanned data with data of the transmitted document.

23. The system of claim 17, wherein the means for collecting handwritten content comprise a handwriting input device of a document receiving device that received the document.

24. The system of claim 17, wherein the means for adding data comprise means for adding data within an input block of the document.

25. The system of claim 17, further comprising means for adding metadata to the unmodifiable document that identifies at least one of that the document is to be ratified and a location of an input block of the document.

26. A document ratification manager stored on a computer-readable medium, the manager comprising:
logic configured to identify a document to be ratified; and
logic configured to add metadata to the document that identifies that the document is to be ratified.

27. The manager of claim 26, further comprising logic configured to identify an input block of the document to which handwritten content is to be added.

28. The manager of claim 27, further comprising logic configured to add metadata to the document that identifies the location of the input block.

29. A document sending device, comprising:
a processing device; and
memory including a document ratification manager that is configured to identify a document to be ratified, add metadata to the document that identifies that the document is to be ratified, add metadata to the document that identifies the location of an input block of the document to which handwritten content is to be added, and transmit the document and metadata to a document receiving device.

30. A document ratification manager stored on a computer-readable medium, the manager comprising:
logic configured to receive an unmodifiable document;
logic configured to collect handwritten content from a recipient of the document; and
logic configured to add data reflective of the handwritten content to the document without replacing original content of the document.

31. The manager of claim 30, wherein the logic configured to collect comprises logic configured to only scan handwritten content that was manually added to a printout of the document.

32. The manager of claim 30, wherein the logic configured to collect handwritten content comprises logic configured to compare data obtained through scanning a print-out of the document with data contained in the received unmodifiable document.

33. The manager of claim 30, wherein the logic configured to collect handwritten content comprises logic configured to collect handwritten marks entered by the recipient in a handwriting input device.

34. The manager of claim 30, wherein the logic configured to add data comprises logic configured to add data within an input block of the unmodifiable document.

35. A document receiving device, comprising:
a processor; and
memory including a document ratification manager that is configured to receive an unmodifiable document, collect handwritten content from a recipient of the document, and add data reflective of the handwritten content to the document without replacing original content of the document.

36. The device of claim 35, wherein the document ratification manager is configured to scan handwritten content that was manually added to a printout of the document by the recipient.

37. The device of claim 36, wherein the document ratification manager is configured to compare data obtained through scanning a print-out of the document with data of the received unmodifiable document.

38. The device of claim 35, wherein the document ratification manager is configured to collect handwritten marks entered by the recipient in a handwriting input device.

39. The device of claim 35, wherein the document ratification manager is configured to add data within an input block of the unmodifiable document.
